(19) United States
(12) Patent Application Publication
(10) Pub. No.: US 2013/0026231 A1
(43) Pub. Date: Jan. 31, 2013

(54) METHOD FOR ESTABLISHING A PROOF ELEMENT DURING THE CONTROL OF A PERSON WITH AN ELECTRONIC PERSONAL DOCUMENT

(71) Applicants: Bruno Rouchouze, St Cyr Sur Mer (FR); Stéfane Mouille, Gemenos (FR); Patrice Plessis, Cuges Les Pins (FR)

(72) Inventors: Bruno Rouchouze, St Cyr Sur Mer (FR); Stéfane Mouille, Gemenos (FR); Patrice Plessis, Cuges Les Pins (FR)

(21) Appl. No.: 13/509,154

(22) PCT Filed: Nov. 9, 2010
(86) PCT No.: PCT/EP10/67138

§ 371 Date: Oct. 17, 2012

(30) Foreign Application Priority Data
Nov. 10, 2009 (EP) 09306084.6

(51) Int. Cl. G06K 5/00

(52) U.S. Cl. 235/380

(57) ABSTRACT

The invention relates to a method for establishing an element of proof when checking an individual using an electronic document. The check involves using a checking means to read at least one data item present in the electronic document. According to the invention, the method involves recording the read data item with at least one data item relating to the check, and signing the read data item and the data item relating to the check using a public key of the checked individual, the signed data items constituting the element of proof of the check.

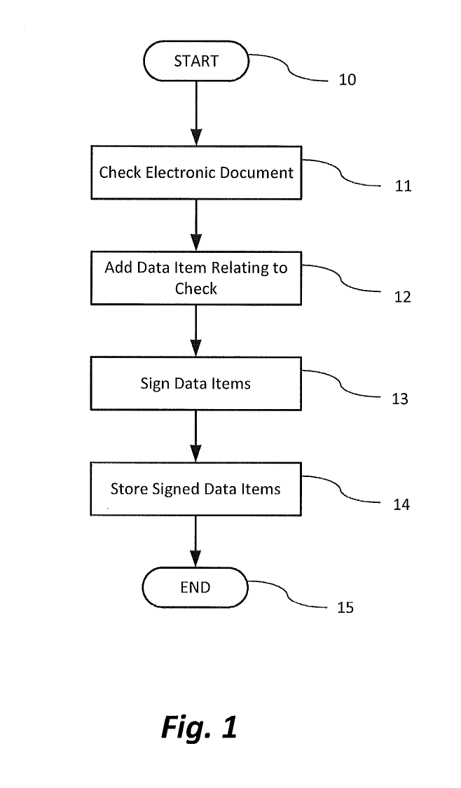

The field of the invention is that of checking personal electronic documents such as passports, identity cards, residence permits, or driving licences, for instance. More precisely, the present invention relates to a method for establishing an element of proof when checking an individual electronic document, upon such check.

Personal electronic documents are intended for being substituted for the paper documents traditionally held by citizens. Such paper documents, such as identity cards or driving licences, will progressively disappear for the benefit of electronic documents such as chip cards or electronic passports containing various items of information on the holder thereof.

For instance, a chip card or an electronic passport may contain the holder's fingerprint, his/her address, data items relating to offences he/she would have committed, data items relating to his/her health, or any other personal information that this individual wishes to keep confidential or at least not to be disclosed to anybody. Keeping personal information confidential is of primary importance in a world where communication is facilitated by all the communication means available to all, whether through the Internet, mobile telephony or future generations' communication networks.

When a sworn officer, for instance, a police officer, a “gendarme” or a customs agent checks an individual's electronic document, for instance his electronic identity card, the agent is given access to the holder's personal information. Such data can be acceded through a checking means, for instance a contact chip card reader or an RFID type reader for a contactless reading. In this latter case, the electronic document includes, in addition to a chip wherein the holder's personal data items are stored, an antenna enabling the reader to access the data items stored in the chip.

The checking means, in the case of the “gendarmerie”, is conventionally composed of a card reader with two slots: one is intended for inserting the card of the checked individual, and the other one for reading, for authentication purposes, data items relating to the checking agent. If the checking agent's card is missing, the data items written on the checked individual's card cannot be read. This makes it possible for the data items stored therein not to be read by a malevolent individual (the thief) when a reader and a individual card have been stolen.

The problem that the present invention intends to remedy is as follows: the agent under oath may be a malevolent individual. During, or after the access to the data items written in the checked individual's electronic document, the agent may copy such data items and use these fraudulently. This fraudulent use may consist in disclosing, for instance through the Internet, the personal data relating to the checked individual, who will just suffer a damage, unless he can establish an element of proof of such check by this agent.

The present invention more particularly aims at enabling a checked individual to establish the proof of his/her check by an agent.

For this purpose, the invention provides for a method for establishing an element of proof when checking an individual using an electronic document belonging to him, with such check consisting in using a checking means to read at least one data item present in said electronic document.

According to the invention, the method consists in recording the read data item with at least one data item relating to said check, and in signing the read data item and the data item relating to the check using a public key of the checked individual, with the signed data items constituting the element of proof of the check.

Thus, if the checking agent discloses the data item/s read in the electronic document during the checking operation, the checked individual will be able to prove that he has been checked by such or such person, at such or such place and on such or such day, using his private key. The agent responsible for the disclosure of the checked individual's personal data shall thus be easily unmasked. This makes it possible to assure the checked individuals that, whatever the data items written in their electronic documents used as identity documents, driving licenses or passports, these shall not be disclosed or whenever they are, it shall be possible to find the agent having fraudulently disclosed such information.

On the other hand, the solution provided by the invention aims at guaranteeing the holder of such an electronic document, that the information items it contains shall not fall in the public domain or, whenever they do, that the person responsible for the disclosure thereof shall be identified.

In a first embodiment, the signed data items are transmitted to an Internet site. This site is for instance accessible to the checked individual further to his request, for instance as per the French model relating to the driving licence with penalty point system consisting in giving, at the police headquarters, the checked individual a password to enable him to consult the points balance on his license.

In a second embodiment, the signed data items are stored in the checked electronic document. The document holder can then retrieve the data items relating to his check. Alternately, the signed data items are stored in any other electronic document, such as a chip card intended for this purpose, for instance.

In a third embodiment, the data items are printed, during the check, on a receipt which is handed over to the checked individual.

The data item relating to the check advantageously matches one of the following elements:
the place of the check;
the date of the check;
the identifier of said used checking means;
the mark of said used checking means;
the type of said used checking means;
the serial number of said used checking means;
the date on which said used checking means was verified;
the name or number of the agent having used said checking means.

Other characteristics and advantages of the invention will appear when reading the following advantageous embodiment of the invention, given as a not limitative illustration and the single appended drawing showing such preferred embodiment of the method according to the invention.

The single appended figure shows a preferred embodiment of the method according to the invention.

Step 10 is a beginning step. During step 11, an individual's electronic document is checked, for instance, during a “gendarmerie” check. Such check may consist in inserting the checked individual's electronic document into a checking means such as a reader and in authorizing the reading of the data items stored therein by inserting an electronic document belonging to the “gendarme” executing the check. After authenticating the gendarme's electronic document, the reader authorizes access to the data items present in the checked individual's electronic document. The data items read by the reader are displayed on a screen to be consulted by the gendarme and/or compared to other data items (for instance comparison of a fingerprint read from the electronic document with a fingerprint read from a fingerprint reader). Upon completion of the reading 11, a step 12 of the method according to the invention consists in adding a data item relating to the check to the read data item. Such data item relating to the check is for instance, the place of the check, the date of the check, the identifier of the used checking means, the mark of the used checking means, the type of the used checking means, the serial number of the used checking means, the date on which said used checking means was verified; the name or number of the agent having used said checking means. Adding such data item may simply consist in concatenating the read data item (or an identifier matching such data item, such as, for instance, a “fingerprint” or “address” mention), in the electronic document with such data item relating to the check.

During step 13, the read data item and the item relating to the check are signed by a public key of the checked individual. Such public key is for instance contained in the checked electronic document. This makes it possible to guarantee that the checked individual will be the only person having subsequently access to the data items relating to his check.

During step 14, the signed data items are stored before the final step 15. Such storage may consist in copying the signed data items into the checked document, in an area reserved for this purpose, or then into another electronic document, such as the checked individual's chip card. The storage may also consist in sending the signed data items to an Internet site, using the checking means.

The checked individual will later have access to such data items, and using his private key, he will be able to establish that he/she has been checked at such or such place by such or such agent. If such agent has committed such misconduct as publishing confidential data items obtained during such check, the checked individual will be able to confound him/her easily.

The above description has been given simply as a non limitative illustration and the specialists will easily imagine other embodiments of the present invention within the scope of the following claims.

1. A method for establishing an element of proof when checking an individual using an electronic document comprising:
using an electronic document reader to read at least one data item present in said electronic document,
recording said read data item and at least one data item relating to said check in a memory, and
signing said read data item and said data item relating to said check using a public key of said checked individual, wherein the signed data items constitute said element of proof of said check.

2. A method according to claim 1, wherein said signed data items are transmitted to an Internet site.

3. A method according to claim 1, wherein said signed data items are stored in said electronic document or any other electronic document.

4. A method according to claim 1, wherein said data item relating to said check matches one of the following elements:
the place of the check;
the date of the check;
an identifier of the electronic document reader;
a mark of said electronic document reader;
the type of said electronic document reader;
the serial number of said electronic document reader;
the date on which said electronic document reader;
the name or number of an agent who used said electronic document reader to read the electronic document.
